(19) United States
(12) Patent Application Publication
(10) Pub. No.: US 2006/0175817 A1
(43) Pub. Date: Aug. 10, 2006

(54) Airbag deployment rate and airbag door sensor system

(76) Inventors: Craig W. White, Grosse Pointe, MI (US); John C. Fisher, Tampa, FL (US); Brian C. Ford, Mt. Clemens, MI (US); Jason M. Doering, Flushing, MI (US)

Correspondence Address: KEY SAFETY SYSTEMS, INC.;PATENT DEPARTMENT, 5300 ALLEN K BREED HIGHWAY, LAKELAND, FL, 33811-1130, US

(21) Appl. No.: 11/054,169

(22) Filed: Feb. 9, 2005

(51) Int. Cl. B60R 21/32

(52) U.S. Cl. 280/735

(57) ABSTRACT

An airbag module has a capacitive vehicle occupant sensor to detect an out-of-position vehicle occupant who is closely spaced from an airbag deployment door. The airbag module incorporates tape sensors, which monitor the rate at which a airbag is deployed, and a vent which can be actuated if the airbag deployment sensor controller or system logic associated with the airbag indicates a premature collision of the airbag with an out-of-position vehicle occupant. A capacitive vehicle occupant sensor is attached to the airbag module, or to the door through which the airbag deploys. In the event a vehicle occupant is closely spaced from the deployment door(s), airbag deployment is inhibited, the airbag module is simultaneously vented, or the airbag deployment profile is otherwise modified.

### BACKGROUND OF THE INVENTION

The present invention relates to airbag modules that employ sensors to monitor the rate at which the airbag is deploying, and which divert inflation gas from the airbag if the airbag deployment slows prematurely, indicating the presence of an out-of-position vehicle occupant.

Airbags that deploy in the event of a vehicle crash form an important part of the overall safety system of an automobile. Airbags in combination with seatbelts and other safety systems reduce death and injury that can occur during a vehicle crash. However, in certain circumstances an airbag can present a hazard to a vehicle occupant if the vehicle occupant is positioned too close to the airbag as it deploys. In such a circumstance the vehicle occupant is described as out-of-position. If a vehicle occupant is out-of-position with respect to an airbag, it is better if the airbag does not deploy, or if deployment has begun, the deployment may be altered by diverting inflation gas from the airbag such as by venting the airbag module. One known approach is to monitor the position of the vehicle occupant with sensors within the passenger compartment and to use safety system logic to not deploy an airbag in those situations where the vehicle occupant is out-of-position. This approach has several difficulties, including that there is a time delay between when the decision to deploy is made and when the actual deployment takes place, and that during this time delay the vehicle occupant may have moved closer to the airbag, and thus may be out-of-position during actual airbag deployment. Sensors within the passenger compartment must also deal with a crash environment where noise, debris, and electromagnetic interference may make reliable detection of vehicle occupant position difficult. Furthermore, sensors within the passenger compartment are typically required to be on at all times, which consumes power and which might be objected to by the consumer.

Another approach to dealing with the out-of-position problem is to mount a sensor on the inside or outside of the airbag. One type of sensor is mounted inside the airbag and uses tapes sewn to the inside of the airbag, which are drawn out of tape cartridges such that the tapes pass by sensors which monitor the rate at which the airbag deploys by monitoring the rate at which tape is withdrawn from the cartridges. Examples of such systems are disclosed in EP 0 990 567 A1, EP 0 812 741 A1, US 2004/0174156 A1, U.S. Pat. No. 6,793,243 B2, and U.S. Pat. No. 6,789,819 B1.

If the rate of tape withdrawal slows down before the airbag has fully deployed, that is an indication that the airbag has collided with an object before full deployment, and that inflation gas can be diverted from the airbag. If the door through which the airbag enters the passenger compartment is formed as part of the vehicle dash or other vehicle structure, the weight of the door will slow the airbag deployment down in a way which can be difficult to distinguish from the situation where an out-of-position vehicle occupant is blocking the door. It is also possible that if the vehicle occupant is too close to the airbag door, the mass and rigidity of the airbag door can cause injury to the vehicle occupant during the initial stages of the airbag deployment, before the tape sensing system has the ability to detect the out-of-position vehicle occupant. What is needed is a means for detecting an out-of-position vehicle occupant closely spaced from an airbag door.

### SUMMARY OF THE INVENTION

The airbag module of this invention employs a vehicle occupant sensor, preferably using the capacitive principal, to detect an out-of-position vehicle occupant, who is closely spaced from an airbag deployment door. The airbag module will preferably incorporate tape sensors which monitor the rate at which the airbag is deployed, and a vent which can be actuated in the event it is determined by the airbag deployment sensor controller or system logic associated with the airbag that the airbag has prematurely collided with an object, which may be an out-of-position vehicle occupant. During the opening of the airbag deployment door(s) the weight of the door(s) can cause one or both of the following to occur:
1. The rate at which the airbag deploys slows so it cannot readily be determined if the airbag is simultaneously being slowed by the airbag door and by impact with an out-of-position vehicle occupant.
2. Injury to the vehicle occupant during the initial stages of the airbag deployment caused by the mass and rigidity of the airbag deployment door(s).

The vehicle occupant sensor is used to detect, before the airbag is deployed, whether a vehicle occupant is so closely spaced from the deployment door(s), that the opening door(s) will impact the out-of-position vehicle occupant. In the event a vehicle occupant is closely spaced from the deployment door(s), airbag deployment is inhibited. Alternatively the airbag may still be fired, but the airbag deployment may be modified, for example by venting the airbag module at the time of initiation of the airbag inflator igniter, or at a selected time after initiation of the airbag inflator igniter.

It is a feature of the present invention to provide an airbag module that incorporates an auxiliary sensor or sensing system capable of detecting an out-of-position vehicle occupant that is in very close proximity to the airbag module deployment door.

It is another feature of the present invention to provide a capacitive sensing system, mounted to or in front of an airbag, which can detect an out-of-position vehicle occupant a short distance in front of the door.

It is a further feature of the present invention to provide a sensor for use in conjunction with an airbag deployment rate sensor, so that the probability of injury to an out-of-position vehicle occupant is reduced by sensing an out-of-position vehicle occupant, so as to inhibit airbag deployment, or divert inflation gas from the airbag during deployment.

It is a still further feature of the present invention to provide a sensor which can determine the lateral position of a closely spaced out-of-position vehicle occupant.

It is yet another feature of the present invention to provide a means of determining differences in various parts of a vehicle occupant's body e.g., hands vs. head, which have varying masses, and whether such parts are in close proximity to the airbag door(s).

It is a yet further feature to provides a means of detecting differences in objects that are in close proximity to the airbag door(s) based on material properties, specifically differences in dielectric strength.

Further features and advantages of the invention will be apparent from the following detailed description when taken in conjunction with the accompanying drawings.

### BRIEF DESCRIPTION OF THE DRAWINGS

FIG. 1 is a schematic, side elevation, cross-section view of the airbag module of this invention positioned behind a vehicle dash, with open airbag doors shown in phantom view.

FIG. 2 is a schematic view of a capacitive sensor used with the airbag module of FIG. 1.

FIG. 3 is a schematic view of an alternative embodiment capacitive sensor used with the airbag module of FIG. 1.

FIG. 4 is a schematic view of another alternative embodiment capacitive sensor for use with the airbag module of FIG. 1.

FIG. 5 is a schematic view of a further alternative embodiment capacitive sensor for use with the airbag module of FIG. 1.

### DETAILED DESCRIPTION OF THE INVENTION

The following commonly owned patent publications teach various aspects of airbag modules and deployment systems and components thereof as well as the manufacture and operation thereof and each is incorporated herein by reference to disclose and teach the present invention: U.S. Pat. No. 6,241,282 B1; U.S. Pat. No. 6,129,379 B; U.S. Pat. No. 6,796,578 B2; US 2004/0178613 A1; US 2004/0178615 A1; U.S. Pat. No. 6,789,818 B2; US 2004/0232673 A1; US 2004/0155442 A1; U.S. Pat. No. 6,793,243 B2; US 2004/0211795 A1; US 2004/0222622 A1; U.S. Pat. No. 6,825,654 B2; US 2004/0207261 A1; US 2004/0251892 A1; US2004/0207388 A1; U.S. Pat. No. 6,789,819 B1; U.S. Pat. No. 6,840,539 B2; and U.S. Pat. No. 6,830,265 B2.

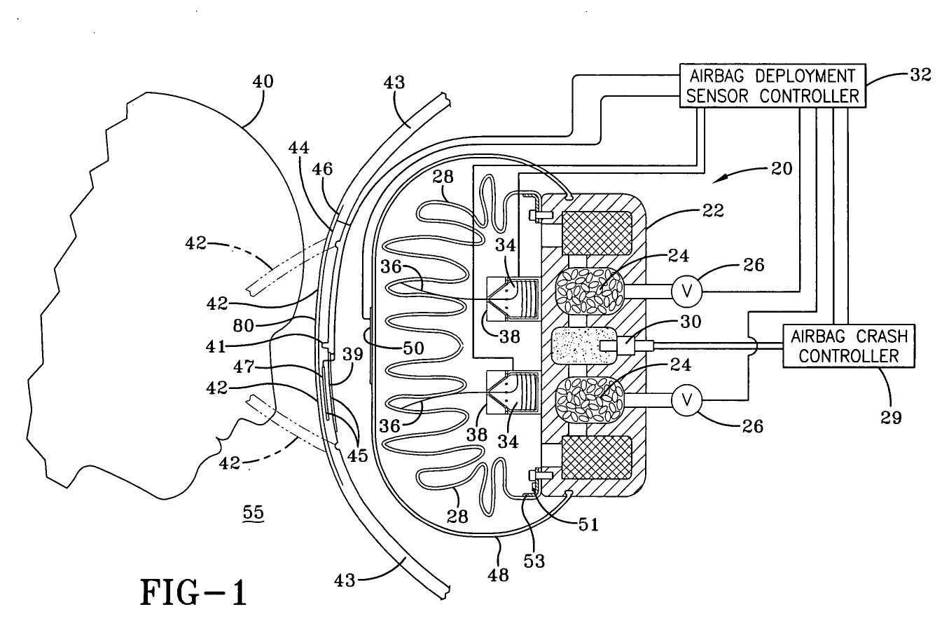

Referring more particularly to FIGS. 1-5, wherein like numbers refer to similar parts, an airbag module 20 is shown in FIG. 1. The airbag module 20 has a gas generator module 22 that incorporates a gas generant 24, and gas vent valves 26. An airbag 28 is connected to the gas generator module 22 so that initiation of an airbag inflator igniter 30, by an airbag crash controller 29 causes the gas generant 24 to deploy the airbag 28. The airbag module 20 has an electronic system 32 in signal receiving relation to a plurality of airbag deployment rate sensors 34. Each airbag deployment rate sensor 34 monitors airbag deployment by monitoring the rate at which a tape 36 is drawn from a cartridge 38 mounted inside the airbag 28. When the airbag 28 collides with an out-of-position vehicle occupant 40 the collision is detected by the deployment rate sensors 34 which detect the premature stopping or slowing of airbag deployment. Once premature stopping or slowing of the airbag is detected, the gas valves 26 are opened to vent inflation gas from the airbag module 28.

FIG. 1 shows a vehicle occupant 40 positioned immediately in front of the doors 42, which form part of a vehicle structure 43, such as a dashboard, and through which the airbag 28 is deployed. If the doors 42, which open along a tear line 41, are sufficiently massive because they form part of the vehicle structure 43, then they will significantly slow the rate of airbag deployment. At the same time, the opening doors 42 can, because of their weight, injure an out-of-position vehicle occupant. This slowing of airbag deployment, whether an out-of-position vehicle occupant is present or not, means that the airbag deployment rate sensors may not be able to detect an impact with a vehicle occupant during a potentially injurious phase of the airbag deployment. Thus the mass of the doors 42 hides the presence of an out-of-position vehicle occupant 40 located immediately in front of the doors 42 because the airbag deployment rate sensors 34 will sense a slowdown caused by impact with the doors 42 whether or not an out-of-position vehicle occupant is present. A capacitive sensor 44 positioned on or within the material making up the door 42 can be designed to detect a large liquid-containing object such as the head or torso of a vehicle occupant. The capacitive sensor 44 may be always active, activated when the onset of a crash event is detected, or activated just before airbag deployment.

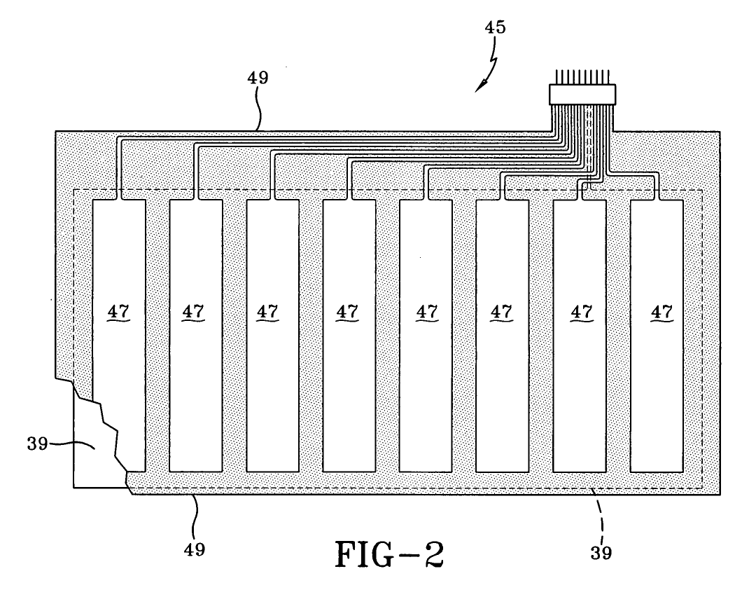

The capacitive sensor 44 may be a single metal plate, or film 46, which forms a capacitor with the vehicle ground. The out-of-position vehicle occupant 40 functions as a grounded body that affects the potential of the metal film 46 charge in a detectable way, when the head or torso of the vehicle occupant 40 is positioned within a few centimeters, e.g. about 5-15 cm (2-6 inches), of the metal film 46. As shown in FIG. 2, an alternative capacitive sensor 45 may comprise a ground plane 39 and two or more adjacent electrodes 47 separated by a dielectric film to make up a series of capacitors. The presence of the out-of-position vehicle occupant 40 affects the electric field developed on the electrodes 47. In general, the charge on the capacitive plates is caused to oscillate at one or more selected frequencies and a change in amplitude of the oscillations is measured to detect an out-of-position vehicle occupant. The operation of the sensor 45 is described more fully in U.S. Pat. No. 6,079,738 B and U.S. Pat. No. 6,135,494 B, which are incorporated herein by reference. Because the range of detection needed is relatively short compared to the prior art vehicle occupant position capacitive sensors, the design of the capacitive sensor can be simpler, and the sensor can incorporate lateral position sensing.

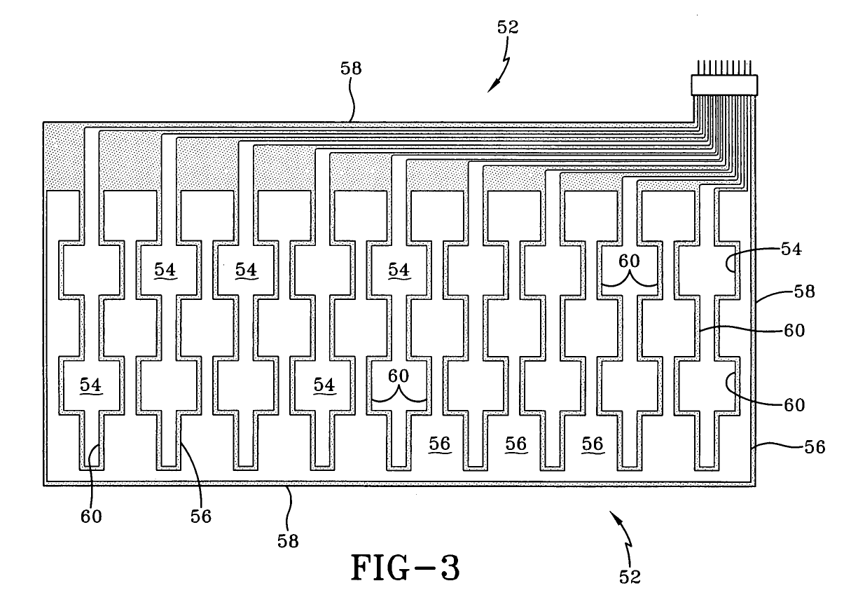

Referring to FIG. 3, a capacitive sensor 52 is shown which can detect a lateral, or side to side position, of a vehicle occupant 40. The alternative sensor 52 is made up of individual capacitive plates 54, with a floating common ground 56 therebetween. The capacitive plates 54 and the common ground 56 can be made by screen printing or otherwise printing a conductive silver ink on one side of an electrically non-conductive flexible polyester film 58. The capacitive sensor 52 has nine capacitive plates 54 arranged side-to-side. Each capacitive plate 54 comprises a plurality of connected trace portions which interdigitate with portions of the common ground 56 to increase the capacitance of each formed capacitor. A field is set up between the capacitive plates 54 and the floating ground 56. An alternating voltage is used to drive the capacitive plates 54 causing the electromagnetic field to expand and collapse between each capacitive plate 54 and the common ground 56. High dielectric objects, which include the human body which consists mostly of liquid, can be detected by the effect the dielectric object has on the electromagnetic fields formed between the capacitive plates 54 and the common ground 56. The presence of the high dielectric object in front of the sensor causes a change of the oscillation amplitude. The change in amplitude of the oscillations is identified by a circuit which may be part of the airbag deployment Sensor controller 32, which may have a single threshold, or may output a varying value which is related to size and distance of the object that changes the output state of the sensor. Each capacitive plate can be driven at the same or a different frequency and individually processed by the circuit. The change in amplitude on each capacitive plate can be monitored, and compared to determine the lateral or side-to-side position of the out-of-position vehicle occupant 40 with respect to the tear line 41. The tear line 41 defines the line from which the doors 42 open to allow the airbag 28 to pass through the vehicle structure 43.

The capacitive plates 54 shown in FIG. 3 are arranged to maximize the length of the capacitive plate borders 60 by comprising multiple line segments. Increased plate border results in increased capacitance which increases the strength of the electromagnetic field created by the capacitive plates 54. The capacitive sensor 52, because it need not sense objects more than a few centimeters from the sensor, is capable of determining the lateral or side-to-side position. The sensor 54 has limited range. This simplifies the location of side-to-side position of an object with respect to the tear line 41 from which the doors 42 open.

Knowledge of the side-to-side position of the out-of-position vehicle occupant 40 allows the airbag to be deployed even if the vehicle occupant 40 is out-of-position, as long as the vehicle occupant is not immediately in front of the opening doors 42. The safety advantages of deploying an airbag can, in the right circumstances, be considerable. Therefore a sensor 52 which can provide more information about the out-of-position vehicle occupant is desirable, so that safety system logic can consider the risks of deployment, versus the risks of non-deployment, with knowledge of the specific position of the obstructing out-of-position vehicle occupant 40. Once the airbag doors 42 are open the airbag deployment rate sensors 34 are effective to detect premature impact with the out-of-position vehicle occupant 40. Thus the airbag deployment rate sensors 34 in combination with the capacitive sensor 52 allow for the following safety system logic:
1. Based on signals from crash sensors, is airbag deployment desirable?; if yes, then:
2. Check the output of the capacitive sensor 52 and determine if airbag deployment through the airbag door(s) 42 can be safely accomplished based on the output of the capacitive sensor 52. If yes, then deploy airbag; and
3. Monitor the output of the airbag deployment rate sensors 34. If the airbag 28 prematurely slows down, then divert inflation gas from the airbag using gas valves 26.

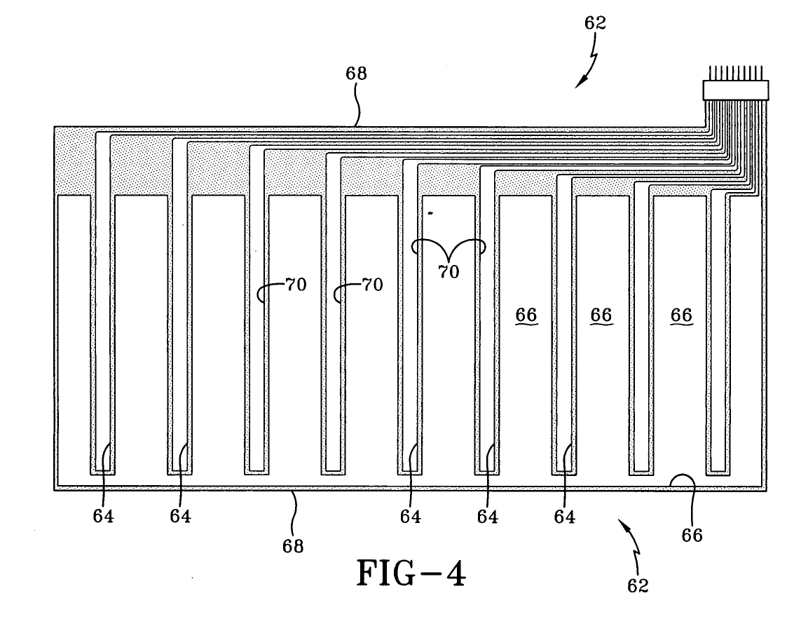

An alternative embodiment capacitive sensor 62 is shown in FIG. 4. The capacitive sensor 62 is similar to the sensor 52, having the same number of capacitive plates 64, and similarly using a floating common ground 66. Also the sensor 62 may be manufactured as a silver ink printed on a polyester film 68. The borders 70 of the capacitive plates 64 are simple straight lines.

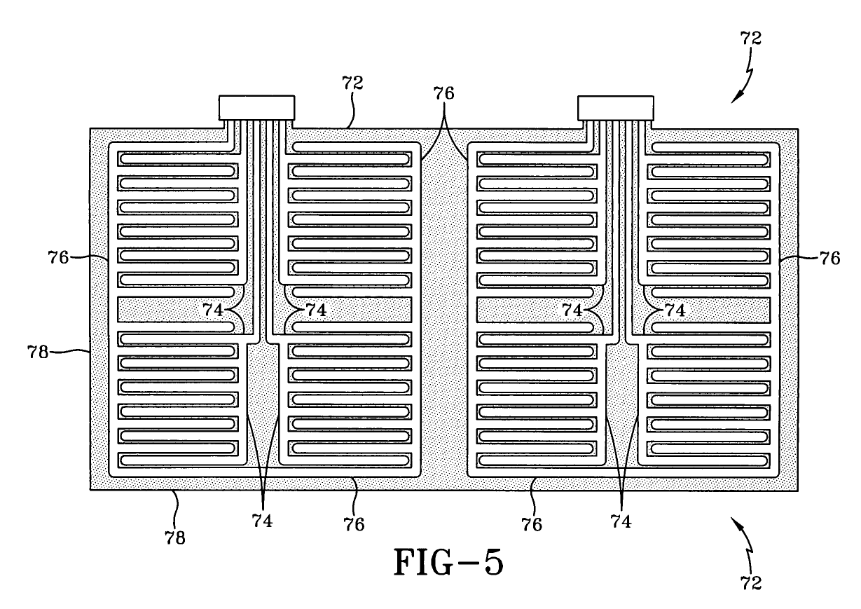

The sensors 62, 52 detect a side-to-side positioning of an out-of-position vehicle occupant, but it may be desirable to detect not only side-to-side position, but up-and-down position. The capacitive sensor 72 shown in FIG. 5 is comprised of eight individual capacitive plates 74, again surrounded by a floating common ground 76. The embodiment illustrated in FIG. 4 uses interdigitating comb like structures for the individual capacitive plates 74, and the common ground 76. Again the capacitive plates 74 and common ground 76 may be constructed by printing conductive ink such as a silver-based ink on one side of a flexible polyester film 78. The capacitive sensor 72 comprises two side-by-side modules, each module being comprised of a two-by-two array of capacitive plates 74. The two modules together create a four-by-two array, which provides a side-to-side resolution which is about twice the vertical resolution. Each of the sensors 62, 52, 72 is arranged to extend across the airbag tear line 41 through which the airbag 28 exits. Thus each sensor is arranged to provide highest resolution with respect to the positioning of the vehicle occupant 40 with respect to the opening doors 42 as shown in FIG. 1.

The scale of the capacitive sensors 52, 62, 72 is selected so the the range which is normally dependent on the area and shape of the individual capacitive plate, and the area and distance to the obstructing dielectric object i.e., the head of an out-of-position vehicle occupant 40. Typically the detection distance is dependent on the size of the object to be detected, and the size of the plates. In the particular embodiments described, geometry of the plates is also related to the airbag module geometry and/or the airbag door(s) geometry. Based on these and other factors, individual capacitive plates must be no more than 70 percent of the target to be sensed. In the embodiments described, individual plate sizes of the sensor 52 is about 7.6 cm by 1.9 cm (3 inches by 0.75 inches), with interlaced, interdigitated grounds. The individual plate sizes of the sensor 62 are about 0.5 cm by 7.6 cm (0.2 inches by 3 inches). The capacitive plates 74 of the sensor 72 are roughly squares about 3.8 cm (1.5 inch) on each side, arranged in a pattern comprising two rows and four columns. The specific geometry of the capacitive plate 74 in the embodiment described comprises conductive “fingers,” about 3.8 cm long by 0.25 cm wide (1.5 inches long by 0.1 inches wide), with a total of 6 “fingers” per plate. Because the maximum sensing distance from the instrument panel is about 5.1-15.2 cm (2-6 inches), and specific biomass sizes and lateral positions must be determined, the maximum dimensions of the plate should be no more than about 5.1 cm by 7.6 cm (2 inches by 3 inches).

By incorporating the airbag doors 42 as part of the vehicle structure, integration with the airbag module is simplified, because a single airbag design can be used with a plurality of vehicles. However, incorporating a sensor into the doors 42 may present a problem with the desirable design goal of minimizing the interface between the vehicle design and the airbag module design. As shown in FIG. 1, a sensor positioning wrap 48 may surround the airbag 28 so as to position a capacitive sensor 50 which forms a part of the airbag module 20. Because the capacitor sensor 50 does not need to be integrated with the airbag doors 42, the same airbag module 20 can simply be reprogrammed to take into account the positioning and door geometry of a particular vehicle model. The capacitor sensor 50 can be similar to the capacitive sensor 44, 52, 62, or 72 as described above. A capacitor sensor 51 can be mounted to a retainer ring 53 which holds the airbag 28 to the gas generator module 22 or a housing (not shown) to which the retainer ring 53 is mounted. The sensor 51 thus senses through the airbag 28 in addition to the doors 42, to the vehicle interior 55. The retainer ring 53 may be a plate which has openings through which gas enters the airbag 28 to cause inflation of the airbag, portions of the plate may form relatively large flat areas within the confines of the airbag which can be used for mounting sensors such as illustrated in FIGS. 2-5.

It should be understood that the capacitive sensor 50 could be mounted to the airbag such as shown in U.S. Pat. No. 6,796,578, to White et al., or it can be held in place by straps instead of the sensor positioning wrap 48 shown in FIG. 1. It should be understood that the capacitive sensors 52, 62 and 72, while described as extending laterally i.e., side-to-side across the tear seam 41, depending on the design of the tear seam, and whether there is one or two doors, may be variously arranged. For example, if only one door is created by airbag deployment the array of capacitors forming the sensor may be positioned on the door side of the tear seam. Other arrangements of the array of capacitors may be required to optimize the information gathering potential of an array of capacitors and for a particular door/airbag arrangement, which will allow best prediction of the safety of deploying a airbag at least through the door, when an out-of-position vehicle occupant is detected.

It should be understood that when in the claims the vehicle occupant or capacitive sensor is described as being mounted to the airbag, this includes a physical attachment to the airbag, or being integrally formed with the airbag, or being mounted to a film which surrounds the airbag.

In general a capacitive sensor 44, 45, 52, 62, 72 can be mounted parallel to the airbag door 42 anywhere from a surface 57 of the airbag door facing the vehicle interior, to a position within the door or spaced from the door opposite the vehicle interior 55, yet within the airbag module so long as the sensor is not blocked by a high dielectric material, and where the sensor has sufficient range to extend at least about 5.1 cm (2 inches) past the surface of the airbag door facing the vehicle interior.

It should be understood that as used herein and in the claims the word tape when referring to the airbag deployment rate sensor is understood to include cloth tape, film tape, metal tape, string, wire, or other lightweight elongated structure which by being drawn past a sensor can detect the rate at which an airbag is deploying.

It is understood that the invention is not limited to the particular construction and arrangement of parts herein illustrated and described, but embraces all such modified forms thereof as come within the scope of the following claims.

We claim:

1. An airbag module comprising:
a gas generator module;
an airbag in gas receiving relation to the gas generator module, the airbag arranged to deploy in a first direction;
a capacitive sensor mounted to the bag, and positioned so that when the capacitive sensor is active, before the airbag is deployed the capacitive sensor has a field of detection which extends in the first direction to detect the presence of an out-of-position vehicle occupant spaced from the airbag; and
an electronic system in signal receiving relation to the capacitive sensor, and in controlling relation to a gas vent valve to divert inflation gas from the airbag if an out-of-position vehicle occupant is detected.

2. The airbag module of claim 1 wherein the electronic system in controlling relation to the gas vent valve include a delay so the airbag can be vented after a selected delay after the airbag is fired.

3. An airbag module comprising:
a gas generator module;
an airbag in gas receiving relation to the gas generator module, the airbag arranged to deploy in a first direction;
a capacitive sensor mounted to the airbag, and positioned so that when the capacitive sensor is active, before the airbag is deployed the capacitive sensor has a field of detection which extends in the first direction to detect the presence of an out-of-position vehicle occupant spaced from the airbag module; and
an electronic system in signal receiving relation to the capacitive sensor, and in controlling relation to the gas generator to modify airbag deployment if an out-of-position vehicle occupant is detected.

4. The airbag module of claim 3 wherein the electronic system controlling relation to the gas generator is one that inhibits airbag deployment.

5. The airbag module of claim 3 wherein the capacitive sensor has only a single capacitive plate.

6. The airbag module of claim 3 wherein the capacitive sensor has an effective field of detection which does not extend substantially beyond about 5.1-15.2 cm (2-6 inches).

7. The airbag module of claim 3 wherein the capacitive sensor comprises at least two capacitive plates.

8. A vehicle mounted airbag system comprising:
a airbag in gas receiving relation to a gas generator module;
a gas generator vent, mounted to the gas generator module for venting gas from the gas generator module;
portions of a vehicle structure forming a door through which the airbag passes as the airbag is inflated, the door defining a swing distance and a door surface facing a vehicle interior;
a vehicle occupant sensor positioned between the airbag and the door surface facing the automobile interior, the vehicle occupant sensor detecting the presence of an out-of-position vehicle occupant within the swing distance of the door;
at least one airbag deployment rate sensor having a tape which is attached to the airbag, so that tape is withdrawn from a cartridge fixedly mounted with respect to the gas generator module as the airbag is inflated by gas from the gas generator module; and
an electronic system in signal receiving relation to the at least one airbag deployment rate sensor, and in signal receiving relation to the vehicle occupant sensor, and in controlling relation to the gas generator, and the gas generator vent.

9. The vehicle mounted airbag system of claim 8 wherein the vehicle occupant sensor is mounted to the door.

10. The vehicle mounted airbag system of claim 8 wherein the vehicle occupant sensor is mounted to the airbag.

11. The vehicle mounted airbag system of claim 8 wherein the vehicle occupant sensor comprises at least one capacitive plate.

12. The vehicle mounted airbag system of claim 11 wherein the capacitive plate is mounted in an interior of the door.

13. The vehicle mounted airbag system of claim 11 where the capacitive plate extends across a tear-line defining the door.

14. The vehicle mounted airbag system of claim 8 wherein the vehicle occupant sensor has an effective field of detection that does not extend substantially beyond the swing distance of the door.

15. The vehicle mounted airbag system of claim 11 wherein the vehicle occupant sensor comprises at least two capacitive plates.

16. An airbag module comprising:
a gas generator module;
a airbag in gas receiving relation to the gas generator module, the airbag arranged to deploy in a first direction;
a gas generator vent, mounted to the gas generator module for venting gas from the gas generator module;
a capacitive sensor mounted to the airbag module, and positioned so that when the capacitive sensor is active it has an effective field of detection which extends in the first direction about 5.1-15.2 cm (2-6 inches), for detecting the presence of an out-of-position vehicle occupant through a closed airbag door;
at least one airbag deployment rate sensor having a tape which is attached to the airbag, so that the tape is withdrawn from a cartridge fixedly mounted with respect to the gas generator module as the airbag is inflated by gas from the gas generator module; and
an electronic system in signal receiving relation to the at least one airbag deployment rate sensor, and in signal receiving relation to the capacitive sensor, and in controlling relation to the gas generator and the gas generator vent.

17. The airbag module of claim 16 wherein the capacitive sensor has only a single capacitive plate.

18. The vehicle mounted airbag system of claim 16 wherein the capacitive sensor is mounted to a retainer ring mounted to the airbag module.

19. The airbag module of claim 16 wherein the capacitive sensor comprises at least two capacitive plates.

20. A capacitive sensor in connection with a vehicle airbag door comprising:
a vehicle structure having an airbag door, the door defining a vehicle interior, into which the door opens;
an electrically non-conductive film positioned parallel to the door and not in the vehicle interior, the film having a first surface;
at least one linear array of at least four capacitive plates, the at least one linear array comprising conductive ink printed on the first surface of the film;
a floating ground comprising conductive ink printed on the first surface of the film and positioned between each capacitive plate of the linear array so that each capacitive plate forms a capacitor with the floating ground;
an oscillator connected to each capacitive plate to cause an electric charge on the capacitor formed by each capacitive plate with the floating ground to oscillate;
a circuit connected across each capacitor which measures the amplitude of the oscillating electric charge on each capacitor; and
a circuit that compares said measured amplitudes.

21. The capacitive sensor of claim 20 wherein the conductive ink contains metallic silver.

22. The capacitive sensor of claim 20 wherein each capacitive plate is rectangular in shape, and the common ground comprises electrically connected rectangular printed areas positioned between each capacitive plate of the linear array of capacitive plates.

23. The capacitive sensor of claim 20 wherein each capacitive plate comprising a plurality of connected trace portions which interdigitate with portions of the common ground to increase the capacitance of each formed capacitor.

24. The capacitive sensor of claim 20 wherein the at least one linear array is part of a two-dimensional array of at least four by two capacitive plates, wherein each capacitive plate forms a capacitor with the floating ground.

25. The capacitive sensor of claim 20 wherein the at least one linear array comprises at least nine capacitive plates.

26. The capacitive sensor of claim 20 wherein the capacitive plates and the floating ground are screen printed, and the conductive ink contains metallic silver.

27. A method of deploying an airbag through a door comprising the steps of:
receiving the output of at least one crash sensor with an airbag crash controller and determining, based on the at least one crash sensor, that a crash is taking place;
if the crash meets a selected criteria for deploying an airbag through the door, than determining from at least a linear array of capacitors mounted between the airbag and a vehicle interior, an amplitude of an oscillating electromagnetic signal on each capacitor;
comparing the amplitude of the oscillating electromagnetic signal on each capacitor to determine a position of an out-of-position vehicle occupant;
if an out-of-position vehicle occupant is not detected or the position of an out-of-position vehicle occupant meets a first selected criteria, then deploying an airbag;
monitoring the output of airbag deployment rate sensors and if the airbag deployment meets second selected criteria indicating impact with an out-of-position vehicle occupant, then venting the airbag.

29. The method of claim 28 further comprising monitoring at least a four by two array of capacitors to determine in at least two dimensions the position of the out-of-position vehicle occupant.

30. The method of claim 27 wherein the first selected criteria for deploying an airbag includes that the out-of-position vehicle occupant is present but positioned away from where the airbag door will begin opening.
